(19) United States
(12) Patent Application Publication
(10) Pub. No.: US 2026/0154108 A1
(43) Pub. Date: Jun. 4, 2026

(54) PROCESSOR LOAD SLEW RATE CONTROL

(71) Applicant: QUALCOMM INCORPORATED, San Diego, CA (US)

(72) Inventors: Krishna Sai Anirudh KATAMREDDY, San Diego, CA (US); Todd Robert SUTTON, Del Mar, CA (US); Suresh SHENOY, San Diego, CA (US)

(21) Appl. No.: 18/969,138

(22) Filed: Dec. 4, 2024

(51) Int. Cl. G06F 9/48

(52) U.S. Cl. CPC G06F 9/4893

(57) ABSTRACT

Processor load slew rate may be controlled to help avoid undesirable supply voltage effects such as overshoot or undershoot. A dynamic processor load current budget may be set during each of successive time intervals, and processor activity level may be throttled according to the dynamic processor load current budget.

### DESCRIPTION OF THE RELATED ART

A computing device may include multiple subsystems, cores, logic circuitry components, etc. Such a computing device may be, for example, a portable computing device, such as a laptop or palmtop computer, a cellular telephone or smartphone, an Internet-of-Things (IOT) device, a wearable device, an automotive computing device, etc. The multiple subsystems, cores and other components of a computing device may be included within different chips or in the same integrated circuit chip. A “system-on-chip” or “SoC” is an example of one such chip that integrates numerous components to provide system-level functionality. For example, an SoC may include one or more types of processors, such as central processing units (CPUs), graphics processing units (GPUs), digital signal processors (DSPs), neural processing units (NPUs), etc.

The current demand experienced by a voltage regulator may vary with the processing load experienced by a processor. For example, when a processor that had been idle suddenly begins executing computation-intensive code (instructions), there may be a rapid increase in current demand at a voltage regulator supplying power to that processor, i.e., a dynamic load surge. Although a voltage regulator may have a transient response that can accommodate expected dynamic load surges, ever more demanding use cases such as artificial intelligence applications may challenge this capability. Exceeding a voltage regulator's transient response capability may impact stability, processing performance, or other key performance indicators. It would be desirable to mitigate such effects of dynamic processor load surges.

### SUMMARY OF THE DISCLOSURE

Systems, methods and other examples are disclosed for processor load slew rate control.

An exemplary method for controlling processor load slew rate may include setting, by current budget allocator circuitry, a dynamic processor load current budget during each of successive time intervals. The method may include throttling, by throttling circuitry, a processor activity level according to the dynamic processor load current budget.

An exemplary system for processor load slew rate control may include current budget allocator circuitry and throttling circuitry. The current budget allocator circuitry may be configured to set a dynamic processor load current budget during each of successive second time intervals. The throttling circuitry may be configured to throttle a processor activity level according to the dynamic processor load current budget.

An exemplary system-on-chip (SoC) may include a processor core and a processor core dynamic slew rate controller. The processor core may be configured to draw a processor load current associated with processing activity level. The processor core dynamic slew rate controller may include current budget allocator circuitry and throttling circuitry. The current budget allocator circuitry may be configured to determine a dynamic processor load current budget during each of successive second time intervals. The throttling circuitry may be configured to throttle the processing activity level according to the dynamic processor load current budget.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a system for processor load slew rate control in a system-on-chip (SoC), in accordance with exemplary embodiments.

FIG. 2 is a bar graph illustrating controlling a rate of increase in processor load current over time, in accordance with exemplary embodiments.

FIG. 3 is a bar graph illustrating controlling a rate of decrease in processor load current over time, in accordance with exemplary embodiments.

FIG. 4 is a block diagram of the processor load current slew rate controller of the system of FIG. 1, in accordance with exemplary embodiments.

FIG. 5 is a block diagram of the dynamic current budget allocator circuitry of the controller of FIG. 4, in accordance with exemplary embodiments.

FIG. 6 is a block diagram similar to FIG. 5, illustrating another example of the dynamic current budget allocator circuitry.

FIG. 7 is a block diagram of the instruction rate prediction circuitry of the controller of FIG. 4, in accordance with exemplary embodiments.

FIG. 8 is a block diagram of the limiter circuitry of the controller of FIG. 4, in accordance with exemplary embodiments.

FIG. 9 is a flow diagram illustrating a method for controlling processor load current slew rate, in accordance with exemplary embodiments.

FIG. 10 is a block diagram of a portable computing device having a processor load current slew rate control feature, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

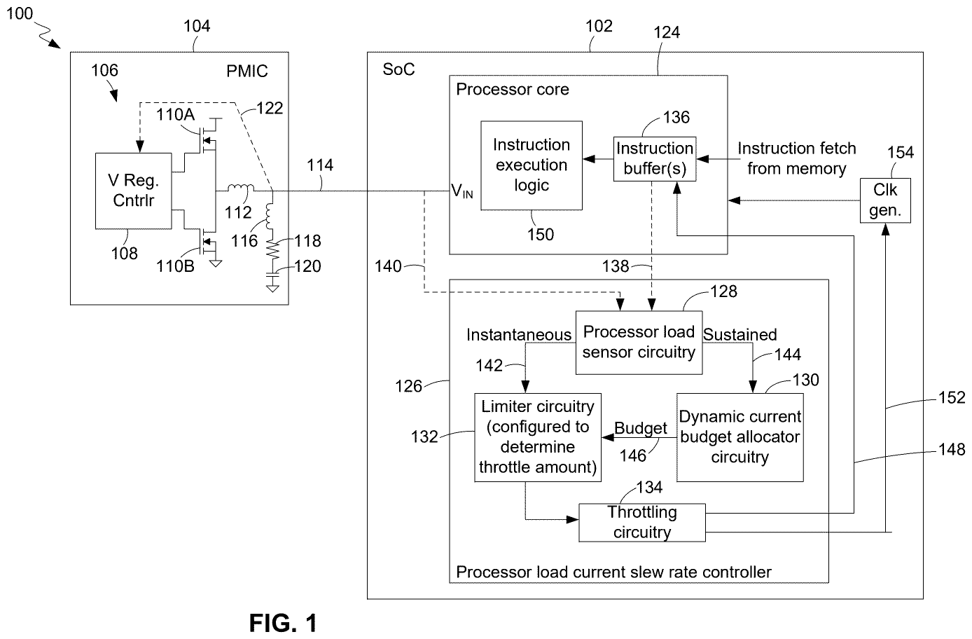

As shown in FIG. 1, an exemplary system 100 may include a system-on-chip (SoC) 102 and a power management integrated circuit (PMIC) 104. The PMIC 104 supplies power to the SoC 102 and, accordingly, includes voltage regulator circuitry 106 along with various power control-related circuitry (not shown for purposes of clarity). The voltage regulator circuitry 106 may include a voltage regulator controller 108, transistors 110A and 110B, and an inductor 112. The path or supply rail 114 through which power is conveyed from the voltage regulator circuitry 106 to the SoC 102 (or a portion thereof) may have parasitic inductance 116 and resistance 118, and there may be additional capacitance 120 as well.

In operation, the voltage regulator controller 108 may control the transistors 110A-110B in a manner that attempts to stabilize the output voltage, based on a feedback signal 122 from the output of the voltage regulator circuitry 106 (i.e., from the path or supply rail 114). It should be understood that the illustrated voltage regulator circuitry configuration including the two transistors 110A and 110B, etc., is intended only as an example; other examples (not shown) of such voltage regulator circuitry may have other numbers and arrangements of transistors, inductances, etc. For example, a switching voltage regulator with 2-phase buck (not shown) is another example of voltage regulator circuitry having a different configuration from the illustrated voltage regulator circuitry 106. It should also be understood that although only the single path or supply rail 114 through which power is conveyed is shown in this example for purposes of clarity, there may be more than one such supply rail.

In the SoC 102, processing circuitry, as exemplified by a processing core 124, may be among the most dynamically demanding consumers of power and may accordingly challenge the ability of the voltage regulator transient response to accommodate dynamic load surges. For example, the voltage regulator circuitry 106 may experience an increase in load current (demand) as the activity level of the processor core 124 increases. Such an increase in processor load current may be very rapid (i.e., a surge) when, for example, the processor core 124 suddenly begins executing computation-intensive code after having been idle or less active. Absent the solutions described herein, a surge in processor load current that exceeds the transient response of the voltage regulator circuitry 106 could cause voltage droop on the supply rail 114. Similarly, a rapid decrease in processor load current could cause voltage overshoot on the supply rail 114. Voltage droop and overshoot may adversely affect processor stability, performance, etc. The solutions described herein may help reduce voltage droop, overshoot, or both, by controlling a rate of change in processor activity level and, as a result, a rate of change in processor load current.

The SoC 102 may include a processor load current slew rate controller 126. The processor load current slew rate controller 126 may be configured to control a rate of change in the activity level of the processor core 124 and, as a result, a rate of change in the processor load current. Although for purposes of clarity only one processor core 124 and only one processor load current slew rate controller 126 are shown in this example, in other examples an SoC may include any number of such processor cores and processor load current slew rate controllers, where each of the processor load current slew rate controllers may be configured to control a rate of change in the activity level of an associated one of the processor cores. The processor load current slew rate controller 126 may include processor load sensor circuitry 128, dynamic current budget allocator circuitry 130, limiter circuitry 132, and throttling circuitry 134.

The processor load sensor circuitry 128 may be configured to sense an indication of processor load. An example of an indication of processor load current is an activity level (e.g., fullness, rate of filling/emptying, etc.) of one or more instruction buffers 136 associated with the processor core 124. Circuitry (not shown) that senses such an activity level as a proxy for load current or power is sometimes referred to as a digital power meter (DPM). Accordingly, in some examples the processor load sensor circuitry 128 may include a DPM (not shown) or similar circuitry that receives a buffer activity indication 138 from the instruction buffers 136. Alternatively, or in addition, in other examples the processor load sensor circuitry 128 may include current sensor circuitry (not shown) that measures processor load current directly, e.g., through a connection 140 to a power rail input (V_{IN}) of the processor core 124.

The processor load sensor circuitry 128 may further be configured to determine an instantaneous processor load current based on sensed processor load over a first time interval and to provide a signal or other indication 142 representing this “instantaneous” processor load current to the limiter circuitry 132. The first time interval need only be long enough to determine an average current, such as, for example, on the order of 10 nanoseconds (ns). The processor load sensor circuitry 128 may still further be configured to determine a “sustained” processor load current based on the sensed processor load over a second time interval longer than the first time interval and to provide a signal or other indication 144 representing this sustained processor load current to the dynamic current budget allocator circuitry 130. The second time interval may be, for example, on the order of 100 ns. It should be understood that the terms “instantaneous” and “sustained” are used only for convenience and are not intended to imply a time interval length, except to the extent that the second (“sustained”) time interval is longer than the first (“instantaneous”) time interval.

As described in further detail below, the dynamic current budget allocator circuitry 130 may be configured to determine a dynamic processor load current budget during each of successive second time intervals based on the sustained processor load current determined in an immediately preceding one of the second time intervals and a step value. The dynamic current budget allocator circuitry 130 may provide a signal or other indication 146 representing this dynamic processor load current budget to the limiter circuitry 132.

The limiter circuitry 132 may be configured to compare the indication 142 of the instantaneous processor load current with the indication 146 of the dynamic processor load current budget. Based on the result of this comparing operation, the limiter circuitry 132 may determine an amount by which to adjust or throttle the activity level of the processor core 124. The throttling circuity 134 may be configured to adjust or throttle the activity level of the processor core 124 based on the throttling amount determined by the limiter circuitry 132.

The activity level of the processor core 124 may be throttled in any of various ways. For example, the throttling circuitry 134 may provide a signal or other indication 148 representing the above-referenced throttling amount to the instruction buffers 136 or to related circuitry such as instruction fetching circuitry (not shown). The instruction buffers 136, instruction fetching circuitry, etc., may insert so-called “dummy” instructions into the instruction stream provided to the instruction execution logic 150 in response to the indication 148. Execution of the dummy instructions by the instruction execution logic 150 may reduce the load current experienced by the instruction execution logic 150. Insertion of dummy instructions for execution by the instruction execution logic 150 in place of more computationally intensive instructions may be an example of a technique known as hardware micro-architectural throttling. Alternatively, or in addition, in another example the throttling circuitry 134 may provide a signal or other indication 152 representing the above-referenced throttling amount to clock generator circuitry 154, which may, in response, adjust a parameter of the clock signal (e.g., duty cycle, frequency, etc.) on which the instruction execution logic 150 or related circuitry operates.

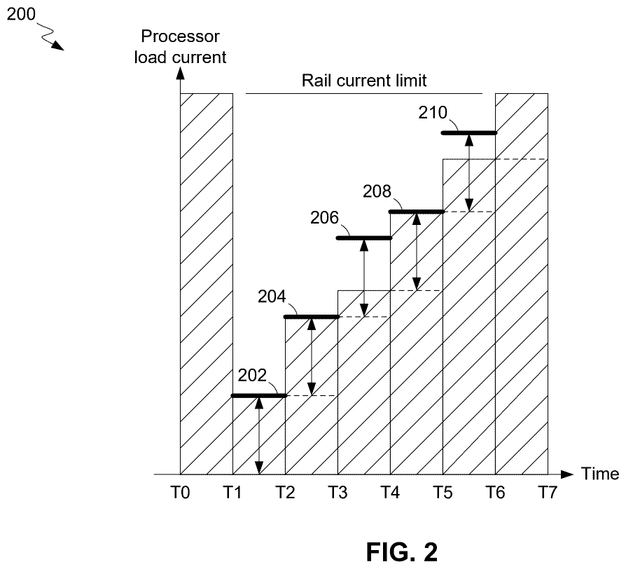

In FIG. 2, a bar graph 200 illustrates controlling or limiting an increase of processor load current from zero to a maximum (e.g., rail current limit) over time. The bar graph 200 may illustrate an example of operation of the above-described system 100 (FIG. 1). The length or cross-hatched portion of each bar in the graph 200 represents the above-described sustained processor load current during each of seven successive exemplary time intervals: T0-T1, T1-T2, T2-T3, T3-T4, T4-T5, T5-T6, and T6-T7. These time intervals are examples of the above-described “second” or “sustained” time interval, which may be, for example, 100 ns. Although in this example the processor load current skews from zero to a rail current limit over seven such time intervals, in other examples the processor load current skew may skew over any number of such time intervals.

Time T0 represents a time of a rapid increase (e.g., to the rail current limit) in the above-described instantaneous processor load current. For example, the processor core 124 (FIG. 1) may have rapidly transitioned from being idle or operating at a very low level of activity to operating at a very high level of activity. This increase may be sustained during the initial time interval T0-T1. Nevertheless, during the initial time interval T0-T1 the processor load current slew rate controller 126 (FIG. 1) may begin operating in the manner described above with regard to FIG. 1 (i.e., providing slew control). During the initial time interval T0-T1, the processor (e.g., processor core 124) can consume current, as capacitors can supply current during this initial time interval T0-T1. Then, in the time T1-T7 the slew control that was initialized in the time interval T0-T1 may control the processor while tracking the processor's current consumption so that discharged capacitors are replenished and voltage droops are not seen.

By time T1, a dynamic processor load current budget 202 has been determined by the dynamic current budget allocator circuitry 130 (FIG. 1). In FIG. 2, each of the double-ended arrows represents a ramp-up step in current. In the illustrated example, the ramp-up step may remain constant, but in other examples the ramp-up step may be adjusted each time interval, in a manner described below. During the time interval T1-T2, the limiter circuitry 132 and throttling circuitry 134 (FIG. 1) operate together to throttle the activity level of the processor core 124 (FIG. 1) by an amount that limits or constrains the instantaneous processor load current to the dynamic processor load current budget 202.

By time T2, a dynamic processor load current budget 204 has been determined by the dynamic current budget allocator circuitry 130 (FIG. 1) by adding the ramp-up step to the sustained processor load current in the previous time interval (T1-T2). During the time interval T2-T3, the limiter circuitry 132 and throttling circuitry 134 (FIG. 1) operate together to throttle the activity level of the processor core 124 (FIG. 1) by an amount that limits or constrains the instantaneous processor load current to the dynamic processor load current budget 204.

By time T3, a dynamic processor load current budget 206 has been determined by the dynamic current budget allocator circuitry 130 (FIG. 1) by adding the ramp-up step to the sustained processor load current in the previous time interval (T2-T3). During the time interval T3-T4, the limiter circuitry 132 and throttling circuitry 134 (FIG. 1) operate together to throttle the activity level of the processor core 124 (FIG. 1) by an amount that limits or constrains the instantaneous processor load current to the dynamic processor load current budget 206. In the illustrated example, the amount of throttling in the time interval T3-T4 is zero (i.e., no throttling is needed) because the instantaneous processor load current in the time interval T3-T4 remains below the dynamic processor load current budget 206. Note that the instantaneous processor load current is not explicitly shown in FIG. 2.

By time T4, a dynamic processor load current budget 208 has been determined by the dynamic current budget allocator circuitry 130 (FIG. 1) by adding the ramp-up step to the sustained processor load current in the previous time interval (T3-T4). During the time interval T4-T5, the limiter circuitry 132 and throttling circuitry 134 (FIG. 1) operate together to throttle the activity level of the processor core 124 (FIG. 1) by an amount that limits or constrains the instantaneous processor load current to the dynamic processor load current budget 208.

By time T5, a dynamic processor load current budget 210 has been determined by the dynamic current budget allocator circuitry 130 (FIG. 1) by adding the ramp-up step to the sustained processor load current in the previous time interval (T4-T5). During the time interval T5-T6, the limiter circuitry 132 and throttling circuitry 134 (FIG. 1) operate together to throttle the activity level of the processor core 124 (FIG. 1) by an amount that limits or constrains the instantaneous processor load current to the dynamic processor load current budget 210. In the illustrated example, the amount of throttling in the time interval T5-6 is zero because the instantaneous processor load current in the time interval T5-T6 remains below the dynamic processor load current budget 210.

At time T6, the sustained processor load current has reached the rail current limit, which is all the current that the voltage regulator circuitry 106 (FIG. 1) is configured to supply, and further throttling would have no effect. In the manner described above, the increase in processor load current from zero or other very low level to the rail current limit over the successive time intervals T0-T6 is controlled or slewed so that the instantaneous processor load current remains within or close to the transient response capability of the voltage regulator circuitry 106. As a result, voltage droop (not shown) at an associated power rail input of the processor core 124 (FIG. 1) may be much less than if the processor load current had been allowed to increase more rapidly to the rail current limit.

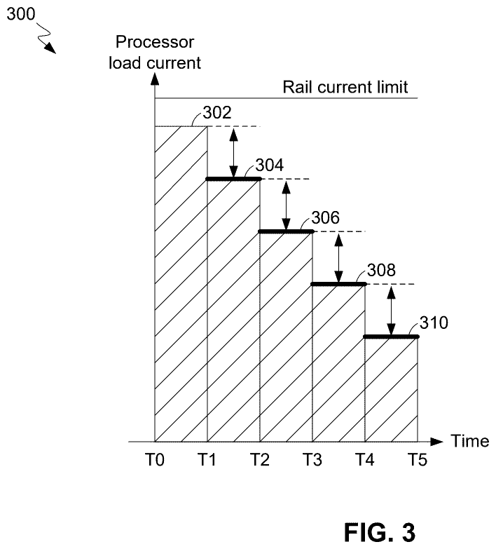

In FIG. 3, a bar graph 300 illustrates controlling or limiting a decrease of processor load current from the rail current limit. The bar graph 300 may illustrate an example of operation of the above-described system 100 (FIG. 1). The length or cross-hatched portion of each bar in the graph 300 represents the above-described sustained processor load current during each of five successive exemplary time intervals: T0-T1, T1-T2, T2-T3, T3-T4, and T4-T5. These time intervals are examples of the above-described “second” or “sustained” time interval, which may be, for example, 100 ns. Although in this example the processor load current skews to a lower level over five such time intervals, in other examples the processor load current may skew over any number of such time intervals.

The time interval T0-T1 represents an example of operation of the processor core 124 (FIG. 1) that results in a high level 302 of sustained processor load current. Then, at time T1 a rapid decrease in the above-described instantaneous processor load current may occur. For example, the processor core 124 (FIG. 1) may have rapidly transitioned from operating at a very high level of activity to being idle or operating at a very low level of activity. Nevertheless, during the time interval T0-T1 the processor load current slew rate controller 126 (FIG. 1) may begin operating in the manner described above with regard to FIG. 1. Note that the instantaneous processor load current is not explicitly shown in FIG. 3.

By time T1, a dynamic processor load current budget 304 has been determined by the dynamic current budget allocator circuitry 130 (FIG. 1) by subtracting a ramp step from (e.g., adding a ramp-down or negative step to) the sustained processor load current in the previous time interval (T0-T1). In FIG. 3, each of the double-ended arrows represents a ramp-down step in current. In the illustrated example, the ramp-down step may remain constant, but in other examples the ramp-down step may be adjusted each time interval, in a manner described below. Time T1 represents a time of a rapid decrease in the processor load current from the level 302, but which is limited or constrained to the dynamic processor load current budget 304. That is, during the time interval T1-T2, the limiter circuitry 132 and throttling circuitry 134 (FIG. 1) operate together to throttle the activity level of the processor core 124 (FIG. 1) by an amount that limits or constrains the instantaneous processor load current from dropping below the dynamic processor load current budget 304.

By time T2, a dynamic processor load current budget 306 has been determined by the dynamic current budget allocator circuitry 130 (FIG. 1) by adding the (negative) ramp-down step to the sustained processor load current in the previous time interval (T1-T2). During the time interval T2-T3, the limiter circuitry 132 and throttling circuitry 134 (FIG. 1) operate together to throttle the activity level of the processor core 124 (FIG. 1) by an amount that limits or constrains the instantaneous processor load current from decreasing below the dynamic processor load current budget 306.

By time T3, a dynamic processor load current budget 308 has been determined by the dynamic current budget allocator circuitry 130 (FIG. 1) by adding the (negative) ramp-down step to the sustained processor load current in the previous time interval (T2-T3). During the time interval T3-T4, the limiter circuitry 132 and throttling circuitry 134 (FIG. 1) operate together to throttle the activity level of the processor core 124 (FIG. 1) by an amount that limits or constrains the instantaneous processor load current from decreasing below the dynamic processor load current budget 308.

By time T4, a dynamic processor load current budget 310 has been determined by the dynamic current budget allocator circuitry 130 (FIG. 1) by adding the (negative) ramp-down step to the sustained processor load current in the previous time interval (T3-T4). During the time interval T4-T5, the limiter circuitry 132 and throttling circuitry 134 (FIG. 1) operate together to throttle the activity level of the processor core 124 (FIG. 1) by an amount that limits or constrains the instantaneous processor load current from decreasing below the dynamic processor load current budget 310.

Although not shown in FIG. 3, by some time after T5 the sustained processor load current will have decreased to zero or an otherwise low level (not shown) corresponding to the processor core 124 (FIG. 1) becoming much less active (e.g., idle), and further throttling would have no effect. In the manner described above, the decrease in processor load current to this low level from the high level 302 over the successive time intervals T0-T6 is controlled or slewed so that the instantaneous processor load current remains within the transient response capability of the voltage regulator circuitry 106 (FIG. 1). As a result, voltage overshoot (not shown) at an associated power rail input of the processor core 124 (FIG. 1) may be much less than if the processor load current had been allowed to decrease more rapidly.

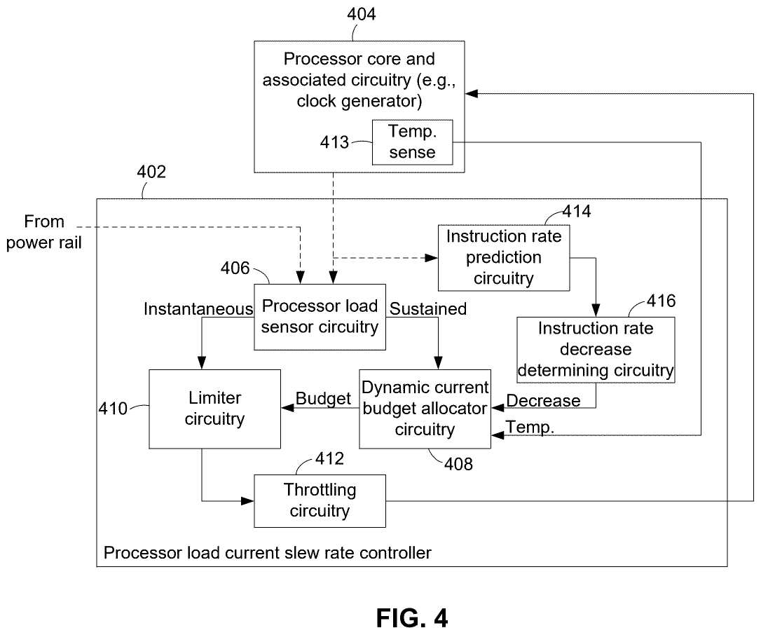

In FIG. 4, a processor load current slew rate controller 402 is shown coupled to a processor core and associated circuitry 404. The processor load current slew rate controller 402 may be an example of the above-described processor load current slew rate controller 126 (FIG. 1). The processor core and associated circuitry 404 may be an example of the above-described processor core 124 (FIG. 1), or the processor core 124 in combination with associated circuitry such as clock generating circuitry, instruction fetching circuitry, etc.

The processor load current slew rate controller 402 may include processor load sensor circuitry 406, dynamic current budget allocator circuitry 408, limiter circuitry 410, and throttling circuitry 412. The processor load sensor circuitry 406, dynamic current budget allocator circuitry 408, limiter circuitry 410, and throttling circuitry 412 may be examples of the above-described (FIG. 1) processor load sensor circuitry 128, dynamic current budget allocator circuitry 130, limiter circuitry 132, and throttling circuitry 134, respectively. Accordingly, the processor load sensor circuitry 406, dynamic current budget allocator circuitry 408, limiter circuitry 410, and throttling circuitry 412 may be configured to operate in the manner described above with regard to the processor load sensor circuitry 128, dynamic current budget allocator circuitry 130, limiter circuitry 132, and throttling circuitry 134, respectively.

The processor load current slew rate controller 402 may further include instruction rate prediction circuitry 414 and instruction rate decrease determining circuitry 416. The instruction rate prediction circuitry 414 and instruction rate decrease determining circuitry 416 may together be configured to predict whether the rate at which instructions are executed will decrease. For example, referring briefly again to FIG. 1, it may be predicted whether the rate at which the instruction execution logic 150 executes instructions will have decreased by the time the instructions on which the prediction is based reach the instruction execution logic 150 from the buffers 136. As described below, the dynamic current budget allocator circuitry 408 may add the above-referenced (negative) ramp-down step to the sustained processor load current when it is predicted that the rate at which instructions are executed will decrease, and to add the above-referenced ramp-up step to the sustained processor load current when it is predicted that the rate at which instructions are executed will increase or remain the same (i.e., will not decrease).

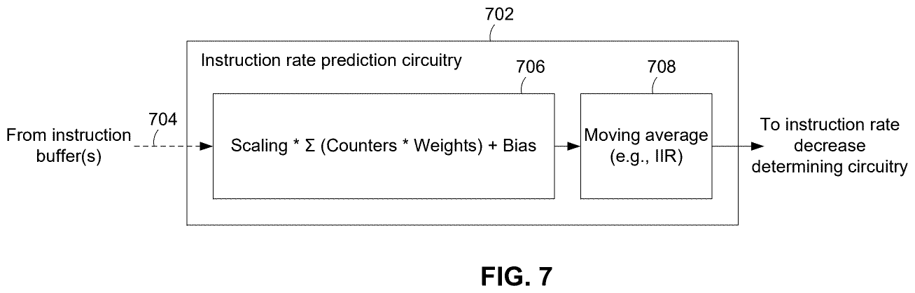

In FIG. 7, exemplary instruction rate prediction circuitry 702 is shown in block diagram form. The instruction rate prediction circuitry 702 may be an example of the instruction rate prediction circuitry 408 (FIG. 4). The instruction rate prediction circuitry 702 may be configured to receive an indication 704 from the above-described one or more instruction buffers 136 (FIG. 1). As noted above, such an indication may represent the activity level (e.g., fullness, rate of filling/emptying, etc.) of the one or more instruction buffers 136 associated with the processor core 124. The indication may be in the form of, for example, one or more counts provided by counters (not shown) associated with the instruction buffers. The instruction rate prediction circuitry 702 may include scaling circuitry 706. The scaling circuitry 706 may be configured to multiply each of the one or more counter values by one or more corresponding weights, and to add a bias value to the result. The scaling circuitry 706 may further be configured to add or sum each of the foregoing values (i.e., counter value multiplied by weight, plus bias value), and then to multiply the sum by a scaling factor. This result may then be provided to moving average circuitry (e.g., an infinite impulse response (IIR) filter) 708. The output of the moving average circuitry 708 may be the output of the instruction rate prediction circuitry 702 and may represent a moving average or prediction of the instruction rate. With reference again to FIG. 4, this prediction of the instruction rate may be provided to the instruction rate decrease determining circuitry 416. Although not shown in similar detail, the instruction rate decrease determining circuitry 416 may be configured to compare successive values of the predicted instruction rate to determine whether there is a decreasing trend, indicating a decrease in the predicted instruction rate. As noted above, the output of the instruction rate decrease determining circuitry 416 may be an indication of whether the predicted instruction rate is decreasing.

In addition, the dynamic current budget allocator circuitry 408 may be configured to receive a temperature indication from a temperature sensor 413 associated with the processor core 404. As described below, the dynamic current budget allocator circuitry 408 may be configured to adjust the ramp-up step based on the temperature indication.

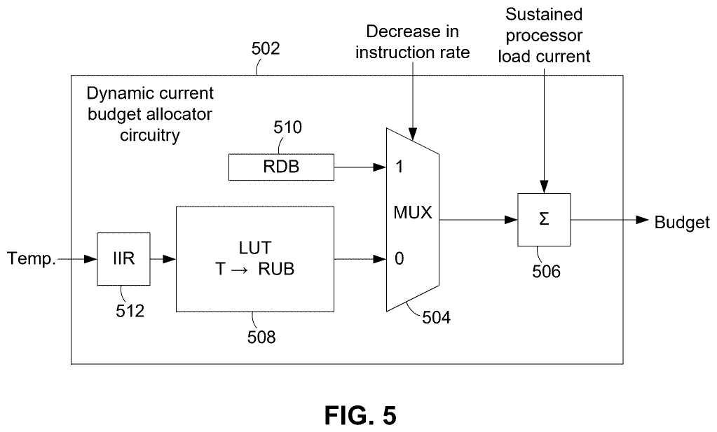

In FIG. 5, exemplary dynamic current budget allocator circuitry 502 is shown in block diagram form. The dynamic current budget allocator circuitry 502 may be an example of the above-described dynamic current budget allocator circuitry 130 (FIG. 1) or 408 (FIG. 4). The dynamic current budget allocator circuitry 502 may include multiplexer circuitry 504 and summing circuitry 506. The multiplexer circuitry 504 may be configured to operate based on the above-described indication of whether the predicted instruction rate is decreasing. The multiplexer circuitry 504 may be configured to select a ramp-up step or ramp-up budget (RUB) value provided by a look-up table (LUT) 508 when the predicted instruction rate is increasing or remaining steady, and to select a ramp-down step or ramp-down budget (RDB) value 510 when the predicted instruction rate is decreasing. The ramp-down step or RDB value may be a constant, i.e., fixed value. The LUT 508 may provide a ramp-up step or RUB value based on the above-referenced temperature measurement. The temperature measurement (e.g., received from the temperature sensor 413 (FIG. 4)) may be provided to an IIR filter 512, and the resulting output of the IIR filter 512 may be provided as an input to the LUT 508. For example, when the temperature is lower the corresponding ramp-up step or RUB in the LUT 508 may be higher, and when the temperature is higher the corresponding ramp-up step or RUB in the LUT 508 may be lower.

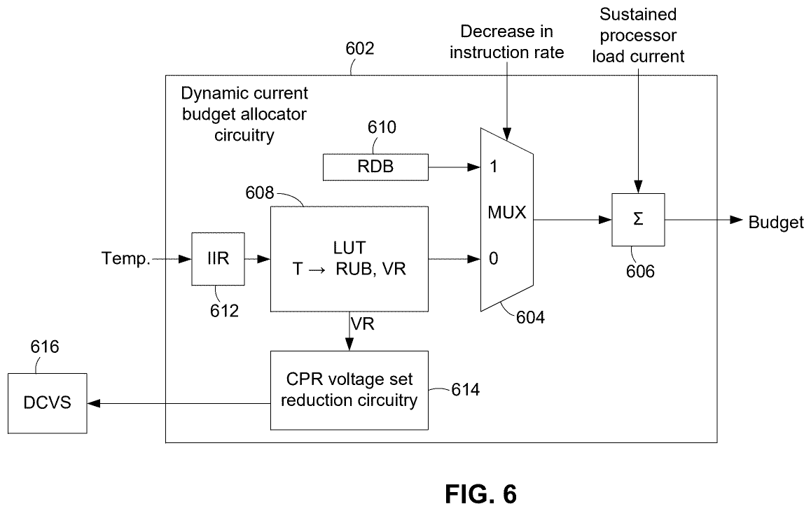

As shown in FIG. 6, additional features may be provided in dynamic current budget allocator circuitry 602, which may be another example of the above-described dynamic current budget allocator circuitry 130 (FIG. 1) or 408 (FIG. 4). The dynamic current budget allocator circuitry 602 may include multiplexer circuitry 604, summing circuitry 606, a LUT 608, a RDB value 610, and an IIR filter 612, which may be similar to the above-described (FIG. 5) multiplexer circuitry 504, summing circuitry 506, LUT 508, RDB value 510, and IIR filter 512, respectively. Nevertheless, the LUT 608 may include an additional output value: a voltage reduction or “VR” value or vote. That is, in response to each input temperature value, the LUT 608 may provide a VR value or vote along with the above-described ramp-up step or RUB value.

The dynamic current budget allocator circuitry 602 may further include core power reduction (CPR) voltage set reduction circuitry 614. As understood by one of ordinary skill in the art, CPR is a technique in which dynamic clock and voltage scaling (DCVS) may be used to throttle processor activity. The CPR voltage set reduction circuitry can provide voltage set values to CPR and DCVS circuitry 616 that are reduced across DCVS corners (or power states) by the amount indicated by the VR value or vote in the LUT 608.

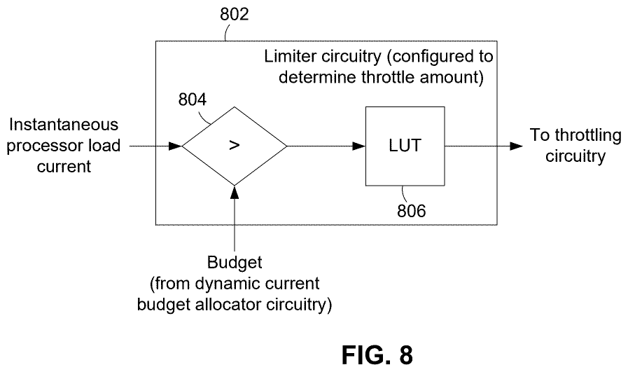

In FIG. 8, limiter circuitry 802 is shown in block diagram form. The limiter circuitry 802 may be an example of the above-described limiter circuitry 132 (FIG. 1) or 410 (FIG. 1). The limiter circuitry 802 may include comparing circuitry 804 and a LUT 806. The comparing circuitry 804 may be configured to compare the above-described instantaneous processor load current with the dynamic processor load current budget. The amount (if greater than zero) by which the instantaneous processor load current exceeds the dynamic processor load current budget may be provided as an input to the LUT 806. Based on this amount, the LUT 806 may provide or indicate an amount by which the processor activity is to be throttled or limited. This indication of a throttling amount may be provided to the throttling circuitry 134 as described above with regard to FIG. 1, or to the throttling circuitry 412 as described above with regard to FIG. 4.

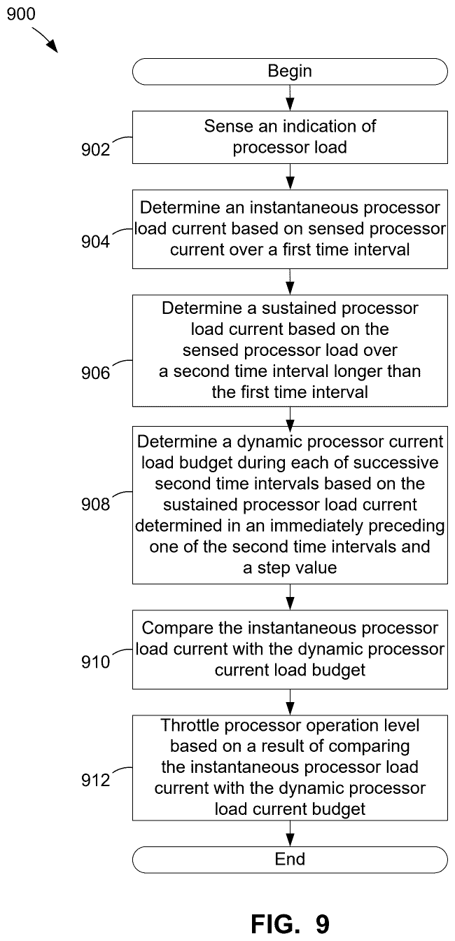

In FIG. 9, an exemplary method 900 for controlling processor load current slew rate is shown in flow diagram form. As indicated by block 902, an indication of processor load may be sensed. This sensing (block 902) may be performed or controlled by, for example, the above-described processor load sensor circuitry 128 (FIG. 1) or 406 (FIG. 4). As indicated by block 904, an instantaneous processor load current may be determined based on sensed processor load over a first time interval. Also, as indicated by block 906, a sustained processor load current may be determined based on the sensed processor load over a second time interval longer than the first time interval. These determinations (blocks 904 and 906) may also be performed or controlled by, for example, the above-described processor load sensor circuitry 128 (FIG. 1) or 406 (FIG. 4).

As indicated by block 908, a dynamic processor load current budget may be determined during each of successive second time intervals based on the sustained processor load current determined in an immediately preceding one of the second time intervals and a step value. This determination (block 908) may be performed or controlled by, for example, the above-described dynamic current budget allocator circuitry 130 (FIG. 1), 408 (FIGS. 4), 502 (FIG. 5) or 602 (FIG. 6).

As indicated by block 910, the instantaneous processor load current determined in accordance with block 904 may be compared with the dynamic processor load current budget determined in accordance with block 906. This comparing (block 910) may be performed or controlled by, for example, the above-described limiter circuitry 132 (FIG. 1), 410 (FIG. 4) or 802 (FIG. 8).

As indicated by block 912, a processor activity level may be throttled based on the result of comparing (block 910) the instantaneous processor load current with the dynamic processor load current budget. This throttling (block 912) may be performed or controlled by the above-described throttling circuitry 134 (FIG. 1).

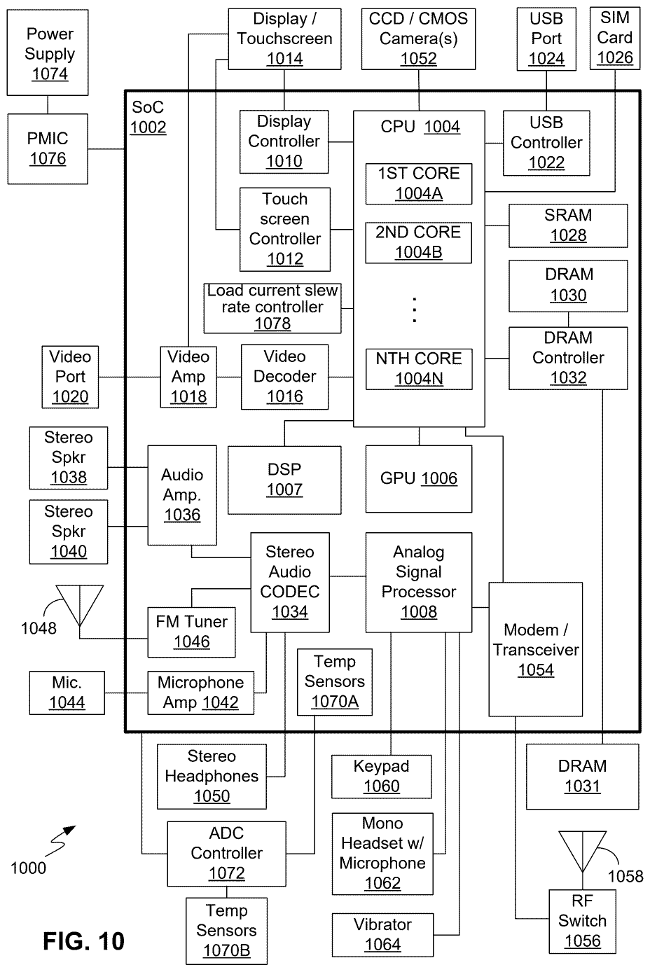

FIG. 10 illustrates an example of a portable computing device (PCD) 1000, in which exemplary embodiments of systems, methods, and other examples of processor load slew rate control in an SoC may be provided. The PCD 1000 may be, for example, laptop or palmtop computer, cellular telephone or smartphone, personal digital assistant, navigation device, smartbook, portable game console, satellite telephone, automotive device, Internet-of-Things (IoT) device, etc.

The PCD 1000 may include an SoC 1002. The SoC 1002 may include a CPU 1004, a GPU 1006, a digital signal processor (DSP) 1007, an analog signal processor 1008, a modem/modem subsystem 1054, or other processors. The CPU 1004 may include one or more CPU cores, such as a first CPU core 1004A, a second CPU core 1004B, etc., through an Nth CPU core 1004N.

A display controller 1010 and a touch-screen controller 1012 may be coupled to the CPU 1004. A touchscreen display 1014 external to the SoC 1002 may be coupled to the display controller 1010 and the touch-screen controller 1012. The PCD 1000 may further include a video decoder 1016 coupled to the CPU 1004. A video amplifier 1018 may be coupled to the video decoder 1016 and the touchscreen display 1014. A video port 1020 may be coupled to the video amplifier 1018. A universal serial bus (USB) controller 1022 may also be coupled to CPU 1004, and a USB port 1024 may be coupled to the USB controller 1022. A subscriber identity module (SIM) card 1026 may also be coupled to the CPU 1004.

The CPU 1004 may be coupled to one or more memories, with which the CPU 1004 or other processors may initiate memory transactions. The one or more memories may include both volatile and non-volatile memories. Examples of volatile memories include static random access memory (SRAM) 1028 and dynamic random access memories (DRAM) 1030 and 1031. Such memories may be internal to the SoC 1002, as in the case of the DRAM 1030, or external to the SoC 1002, as in the case of the DRAM 1031. A DRAM controller 1032 coupled to the CPU 1004 may control the writing of data to, and reading of data from, the DRAM 1030.

A stereo audio CODEC 1034 may be coupled to the analog signal processor 1008. Further, an audio amplifier 1036 may be coupled to the stereo audio CODEC 1034. First and second stereo speakers 1038 and 1040, respectively, may be coupled to the audio amplifier 1036. In addition, a microphone amplifier 1042 may be coupled to the stereo audio CODEC 1034, and a microphone 1044 may be coupled to the microphone amplifier 1042. A frequency modulation (FM) radio tuner 1046 may be coupled to the stereo audio CODEC 1034. An FM antenna 1048 may be coupled to the FM radio tuner 1046. Further, stereo headphones 1050 may be coupled to the stereo audio CODEC 1034. Other devices that may be coupled to the CPU 1004 include one or more digital (e.g., CCD or CMOS) cameras 1052.

The RF transceiver or modem subsystem 1054 may be coupled to the analog signal processor 1008 and the CPU 1004. An RF switch 1056 may be coupled to the modem subsystem 1054 and an RF antenna 1058. In addition, a keypad 1060, a mono headset with a microphone 1062, and a vibrator device 1064 may be coupled to the analog signal processor 1008.

The SoC 1002 may have one or more internal or on-chip thermal sensors 1070A and may be coupled to one or more external or off-chip thermal sensors 1070B. An analog-to-digital converter controller 1072 may convert voltage drops produced by the thermal sensors 1070A and 1070B to digital signals.

A power supply 1074 and a power management integrated circuit (PMIC) 1076 may supply power to the SoC 1002. A processor load current slew rate controller 1078, which may be an example of the above-described processor load current slew rate controller 126 (FIG. 1) or 402 (FIG. 4), may be coupled to the CPU 1004. Although for purposes of clarity in FIG. 10 the CPU 1004 is shown coupled to only the one processor load current slew rate controller 1078, each core 1004A-1004N may be coupled to one such processor load current slew rate controller. Further, although similarly not shown for purposes of clarity, other processors, such as the GPU 1006, DSP 1007, etc., or cores thereof, may be coupled to such a processor load current slew rate controller.

Implementation examples are described in the following numbered clauses:
1. A method for processor load slew rate control, comprising:
   setting, by current budget allocator circuitry, a dynamic processor load current budget during each of successive second time intervals;
   throttling, by throttling circuitry, a processor activity level according to the dynamic processor load current budget.
2. The method of clause 1, further comprising:
   sensing, by sensor circuitry, an indication of processor load;
   determining, by the sensor circuitry, an indication of instantaneous processor load current based on a sensed indication of processor load over a first time interval;
   determining, by the sensor circuitry, an indication of sustained processor load current based on the sensed indication of processor load over the second time interval, wherein the second time interval is longer than the first time interval; and
   comparing, by limiter circuitry, the indication of instantaneous processor load current with the dynamic processor load current budget;
   wherein setting the dynamic processor load current budget is based on the indication of sustained processor load current determined in an immediately preceding one of the second time intervals and a step value; and
   wherein throttling the processor activity level is based on a result of comparing the indication of instantaneous processor load current with the dynamic processor load current budget.
3. The method of clause 1 or 2, wherein setting the dynamic processor load current budget comprises determining a processor instruction rate change.
4. The method of clause 2, further comprising determining the step value based on a ramp-down constant when the processor instruction rate change is a decrease.
5. The method of clause 2 or 4, further comprising:
   sensing a temperature associated with processor operation; and
   determining the step value based on a sensed temperature when the processor instruction rate change is not a decrease.
6. The method of any of clauses 1-5, wherein throttling processor activity level comprises at least one of: micro-architectural throttling and clock signal dithering.
7. The method of any of clauses 1-6, wherein the indication of processor load current and the processor operation level are associated with a processing core in a system-on-chip (SoC).
8. A system for processor load slew rate control, comprising:
   current budget allocator circuitry configured to set a dynamic processor load current budget during each of successive second time intervals; and
   throttling circuitry configured to throttle a processor activity level according to the dynamic processor load current budget.
9. The system of clause 8, further comprising:
   sensor circuitry configured to sense an indication of processor load, to determine an indication of instantaneous processor load current based on a sensed indication of processor load over a first time interval, and to determine an indication of sustained processor load current based on the sensed indication of processor load over the second time interval, wherein the second time interval is longer than the first time interval, and wherein the current budget allocator circuitry is configured to set the dynamic processor load current budget based on the indication of sustained processor load current determined in an immediately preceding one of the second time intervals and a step value; and
   limiter circuitry configured to compare the indication of instantaneous processor load current with the dynamic processor load current budget, wherein the throttling circuitry is configured to throttle the processor activity level based on a result of comparing the indication of instantaneous processor load current with the dynamic processor load current budget.
10. The system of clause 8 or 9, wherein the current budget allocator circuitry is configured to determine a processor instruction rate change.
11. The system of clause 9, wherein the current budget allocator circuitry is configured to determine the step value based on a ramp-down constant when the processor instruction rate change is a decrease.
12. The system of clause 9 or 11, wherein the current budget allocator circuitry is configured to determine the step value based on a sensed temperature associated with a processor when the processor instruction rate change is not a decrease.
13. The system of any of clauses 8-12, wherein the throttling circuitry is configured to control at least one of: micro-architectural throttling and clock signal dithering.
14. The system of any of clauses 8-13, wherein the indication of processor load current and the processor operation level are associated with a processing core in a system-on-chip (SoC).
15. A system-on-chip (SoC), comprising:
   a processor core configured to draw a processor load current associated with processing activity level; and
   a processor core dynamic slew rate controller, including current budget allocator circuitry and throttling circuitry;
   wherein the current budget allocator circuitry is configured to set a dynamic processor load current budget during each of successive second time intervals; an
   wherein the throttling circuitry is configured to throttle the processing activity level according to the dynamic processor load current budget.
16. The SoC of clause 15, wherein the processor core dynamic slew rate controller further comprises:
   sensor circuitry configured to sense an indication of processor load, to determine an indication of instantaneous processor load current based on sensed processor load current over a first time interval, and to determine an indication of sustained processor load current based on the sensed processor load current over the second time interval, wherein the second time interval is longer than the first time interval, and wherein the current budget allocator circuitry is configured to set the dynamic processor load current budget based on the indication of sustained processor load current determined in an immediately preceding one of the second time intervals and a step value; and
   limiter circuitry configured to compare the indication of instantaneous processor load current with the dynamic processor load current budget, wherein the throttling circuitry is configured to throttle the processor activity level based on a result of comparing the indication of instantaneous processor load current with the dynamic processor load current budget.
17. The SoC of clause 15 or 16, wherein the current budget allocator circuitry is configured to determine a processor instruction rate change.
18. The SoC of clause 16, wherein the current budget allocator circuitry is configured to determine the step value based on a ramp-down constant when the processor instruction rate change is a decrease.
19. The SoC of clause 16 or 18, wherein the current budget allocator circuitry is configured to determine the step value based on a sensed temperature associated with a processor when the processor instruction rate change is not a decrease.
20. The SoC of any of clauses 15-19, wherein the throttling circuitry is configured to control at least one of: micro-architectural throttling and clock signal dithering.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A method for processor load slew rate control, comprising:
setting, by current budget allocator circuitry, a dynamic processor load current budget during each of successive second time intervals; and
throttling, by throttling circuitry, a processor activity level according to the dynamic processor load current budget.

2. The method of claim 1, further comprising:
sensing, by sensor circuitry, an indication of processor load;
determining, by the sensor circuitry, an indication of instantaneous processor load current based on a sensed indication of processor load over a first time interval;
determining, by the sensor circuitry, an indication of sustained processor load current based on the sensed indication of processor load over the second time interval, wherein the second time interval is longer than the first time interval; and
comparing, by limiter circuitry, the indication of instantaneous processor load current with the dynamic processor load current budget;
wherein setting the dynamic processor load current budget is based on the indication of sustained processor load current determined in an immediately preceding one of the second time intervals and a step value; and
wherein throttling the processor activity level is based on a result of comparing the indication of instantaneous processor load current with the dynamic processor load current budget.

3. The method of claim 1, wherein setting the dynamic processor load current budget comprises determining a processor instruction rate change.

4. The method of claim 2, further comprising determining the step value based on a ramp-down constant when the processor instruction rate change is a decrease.

5. The method of claim 2, further comprising:
sensing a temperature associated with processor operation; and
determining the step value based on a sensed temperature when the processor instruction rate change is not a decrease.

6. The method of claim 1, wherein throttling processor activity level comprises at least one of: micro-architectural throttling and clock signal dithering.

7. The method of claim 1, wherein the indication of processor load current and the processor operation level are associated with a processing core in a system-on-chip (SoC).

8. A system for processor load slew rate control, comprising:
current budget allocator circuitry configured to set a dynamic processor load current budget during each of successive second time intervals; and
throttling circuitry configured to throttle a processor activity level according to the dynamic processor load current budget.

9. The system of claim 8, further comprising:
sensor circuitry configured to sense an indication of processor load, to determine an indication of instantaneous processor load current based on a sensed indication of processor load over a first time interval, and to determine an indication of sustained processor load current based on the sensed indication of processor load over the second time interval, wherein the second time interval is longer than the first time interval, and wherein the current budget allocator circuitry is configured to set the dynamic processor load current budget based on the indication of sustained processor load current determined in an immediately preceding one of the second time intervals and a step value; and
limiter circuitry configured to compare the indication of instantaneous processor load current with the dynamic processor load current budget, wherein the throttling circuitry is configured to throttle the processor activity level based on a result of comparing the indication of instantaneous processor load current with the dynamic processor load current budget.

10. The system of claim 8, wherein the current budget allocator circuitry is configured to determine a processor instruction rate change.

11. The system of claim 9, wherein the current budget allocator circuitry is configured to determine the step value based on a ramp-down constant when the processor instruction rate change is a decrease.

12. The system of claim 9, wherein the current budget allocator circuitry is configured to determine the step value based on a sensed temperature associated with a processor when the processor instruction rate change is not a decrease.

13. The system of claim 8, wherein the throttling circuitry is configured to control at least one of: micro-architectural throttling and clock signal dithering.

14. The system of claim 8, wherein the indication of processor load current and the processor operation level are associated with a processing core in a system-on-chip (SoC).

15. A system-on-chip (SoC), comprising:
a processor core configured to draw a processor load current associated with processing activity level; and
a processor core dynamic slew rate controller, including current budget allocator circuitry and throttling circuitry;
wherein the current budget allocator circuitry is configured to set a dynamic processor load current budget during each of successive second time intervals; and
wherein the throttling circuitry is configured to throttle the processing activity level according to the dynamic processor load current budget.

16. The SoC of claim 15, wherein the processor core dynamic slew rate controller further comprises:
sensor circuitry configured to sense an indication of processor load, to determine an indication of instantaneous processor load current based on sensed processor load current over a first time interval, and to determine an indication of sustained processor load current based on the sensed processor load current over the second time interval, wherein the second time interval is longer than the first time interval, and wherein the current budget allocator circuitry is configured to set the dynamic processor load current budget based on the indication of sustained processor load current determined in an immediately preceding one of the second time intervals and a step value; and
limiter circuitry configured to compare the indication of instantaneous processor load current with the dynamic processor load current budget, wherein the throttling circuitry is configured to throttle the processor activity level based on a result of comparing the indication of instantaneous processor load current with the dynamic processor load current budget.

17. The SoC of claim 15, wherein the current budget allocator circuitry is configured to determine a processor instruction rate change.

18. The SoC of claim 16, wherein the current budget allocator circuitry is configured to determine the step value based on a ramp-down constant when the processor instruction rate change is a decrease.

19. The SoC of claim 16, wherein the current budget allocator circuitry is configured to determine the step value based on a sensed temperature associated with a processor when the processor instruction rate change is not a decrease.

20. The SoC of claim 15, wherein the throttling circuitry is configured to control at least one of: micro-architectural throttling and clock signal dithering.
